(19) United States
(12) Patent Application Publication
(10) Pub. No.: US 2016/0188033 A1
(43) Pub. Date: Jun. 30, 2016

(54) TOUCH PANEL WITH FINGERPRINT RECOGNITION

(71) Applicant: Chih-Chung Lin, Taipei City (TW)

(72) Inventor: Chih-Chung Lin, Taipei City (TW)

(21) Appl. No.: 14/583,110

(22) Filed: Dec. 25, 2014

(51) Int. Cl. G06F 3/044; G06F 3/041; G06K 9/00

(52) U.S. Cl. CPC G06F 3/044; G06K 9/0002; G06F 3/0416; G06F 2203/04112

(57) ABSTRACT

A touch panel with fingerprint recognition comprises a glass substrate, an electrode layer, a first insulated layer, and a fingerprint recognition sensing layer. The glass substrate has a first plane and a second plane. The electrode layer is disposed on the second plane and has plural first electrodes, plural second electrodes, and plural metal traces. The first electrodes and the second electrodes are selectively electrically connected to the metal traces. The first insulated layer covers an overlapping of the first electrodes and the second electrodes. The fingerprint recognition sensing layer is disposed on the first plane and has plural fingerprint recognition chips and plural transmission lines. The fingerprint recognition chips are electrically connected to the transmission lines. By means of the integration of the fingerprint recognition chips and the touch panel, the whole manufacturing cost is greatly decreased and the accuracy of fingerprint recognition is improved.

### BACKGROUND OF THE INVENTION

1. Field of the Invention

The present invention relates to a touch panel with fingerprint recognition and in particular to a touch panel with fingerprint recognition which integrates the fingerprint recognition chips into the touch panel.

2. Description of Prior Art

With a rapid development of multimedia, smart mobile electronic devices such as mobile phones, PDAs, digital cameras, notebook computers, tablet computers, and wearable devices have become people's necessities in daily life. However, these mobile electronic devices have significant feature of personalization. Thus, if these mobile electronic devices are missing or usurped, the stored information such as the phonebook, pictures, and data may be used improperly by others, causing unnecessary damage.

Therefore, such products need to be equipped with functions of authentication and permission management to ensure the user's privacy and security. The currently main adopted authentication is password-protected. Firstly, the user needs to input a correct password into the mobile electronic device and then is allowed to access the manipulation page. However, the security level of the password protection is relatively low because the password is easily leaked or hacked. Also, it is troublesome if the password is missing. Thus the mobile electronic devices with authentication using fingerprint recognition appear on the market. Since people's fingerprints are different, the fingerprint is unique. As a result, the authentication using fingerprint recognition has really high security level. Besides, it is relatively convenient to use the fingerprint recognition for authentication which avoids the troubles of the user memorizing and inputting the password.

The current fingerprint recognition system used commonly in the handheld device or mobile device is independently designed and disposed on a fixed side of the notebook computer, or at a fixed position on the backside or bottom side of one end of the handheld mobile device, which cannot be integrated effectively into the touch panel of the handheld mobile device to decrease the volume of the handheld mobile device. Besides, the packaging module of the traditional fingerprint recognition chip mainly comprises a substrate, a chip, and a molding body. The chip is disposed on the substrate and electrically connected to the substrate. The molding body is disposed over the surface of the substrate and on the chip.

In general, when the finger touches the sensing area, the sensitivity of the packaging module of the chip will decrease because multiple layers of films stack on the chip and thus the whole chip packaging module has a larger thickness.

Moreover, the traditional swipe-type fingerprint recognition system is orientation dependent with a long recognition time and it needs to be disposed independently, which results in poor structural integration and convenience of use.

### SUMMARY OF THE INVENTION

Thus, to effectively overcome the above problems, the primary objective of the present invention is to provide a touch panel with fingerprint recognition, which integrates the fingerprint recognition chips into the touch panel.

To achieve the above objectives, the present invention provides a touch panel with fingerprint recognition, which comprises a glass substrate, an electrode layer, a first insulated layer, and a fingerprint recognition sensing layer.

The glass substrate has a first plane and a second plane. The first plane and the second plane are disposed on an upper side and a lower side of the glass substrate, respectively. The first plane defines a touch area and a non-touch area which are adjacent to each other. The electrode layer is disposed on the second plane of the glass substrate. The electrode layer has a plurality of first electrodes, a plurality of second electrodes, and a plurality of metal traces. The first electrodes and the second electrodes are selectively electrically connected to the metal traces. The first insulated layer covers part of an overlapping of the first electrodes and the second electrodes. The fingerprint recognition sensing layer is disposed on the first plane of the glass substrate and has a plurality of fingerprint recognition chips and a plurality of transmission lines. The fingerprint recognition chips are electrically connected to the transmission lines.

By means of integrating the fingerprint recognition chips into the touch panel, the whole manufacturing cost is greatly decreased and the accuracy of fingerprint recognition is improved.

### BRIEF DESCRIPTION OF DRAWING

FIG. 1 is a perspective exploded view of the touch panel with fingerprint recognition according to the first embodiment of the present invention;

FIG. 2 is an assembled cross-sectional view of the touch panel with fingerprint recognition according to the first embodiment of the present invention;

FIG. 3 is an assembled cross-sectional view of the touch panel with fingerprint recognition according to the second embodiment of the present invention;

FIG. 4 is an assembled cross-sectional view of the touch panel with fingerprint recognition according to the third embodiment of the present invention;

FIG. 5 is a top view of the fingerprint recognition sensing layer of the touch panel with fingerprint recognition according to the fourth embodiment of the present invention; and

FIG. 5a is a local enlarged view of FIG. 5.

### DETAILED DESCRIPTION OF THE INVENTION

The above objectives of the present invention and the features of structure and function of the present invention are described according to preferred embodiments in accompanying figures.

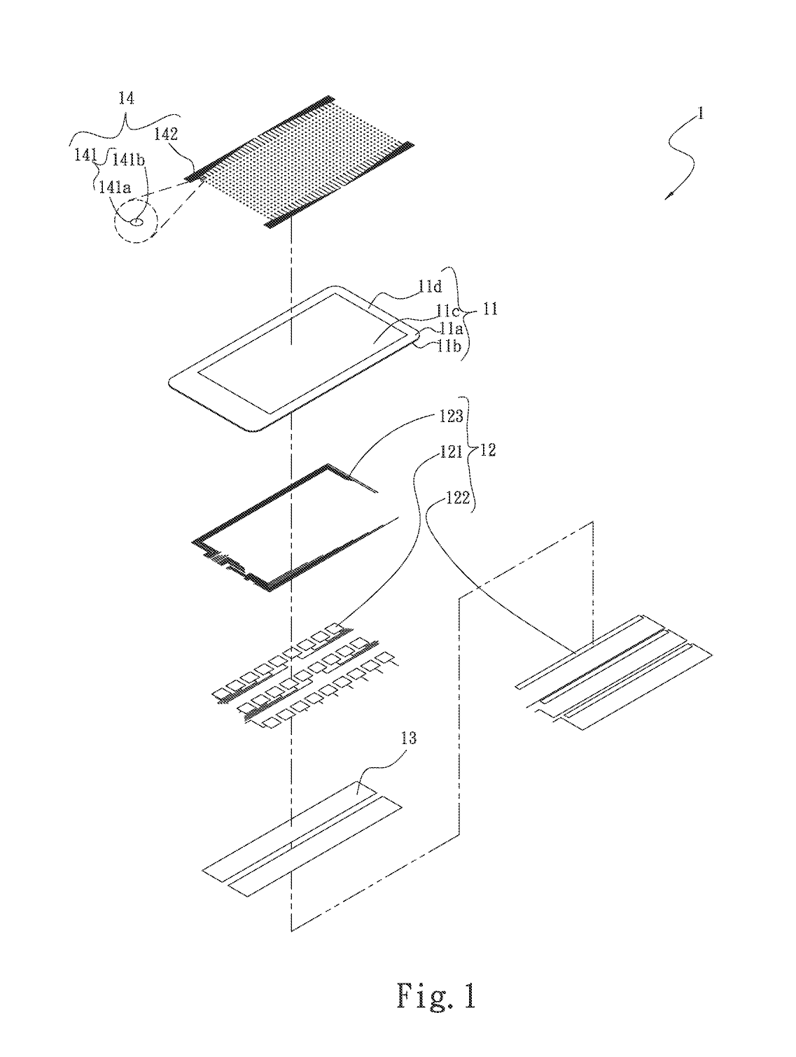

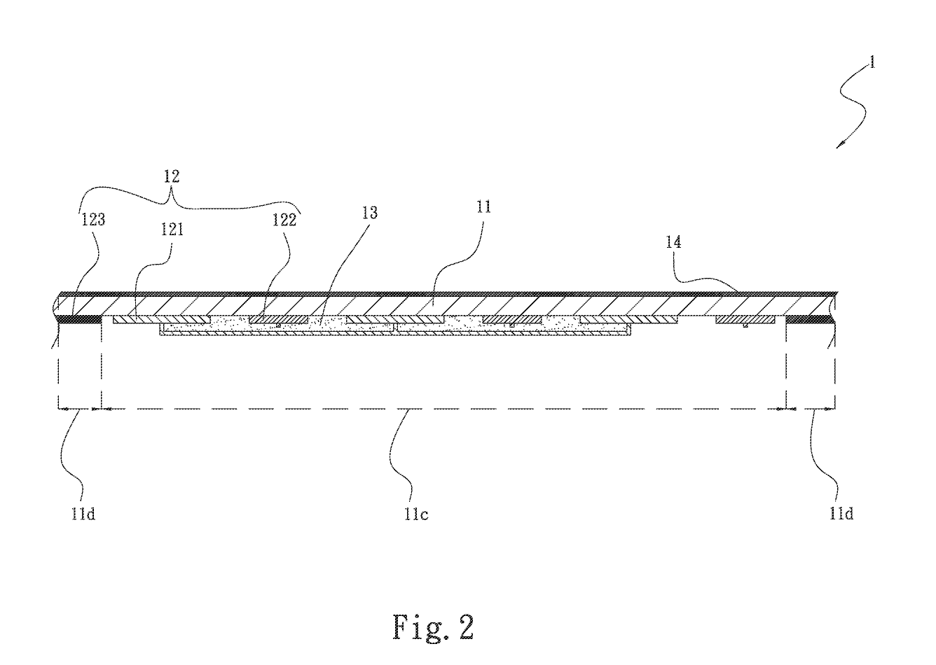

Please refer to FIGS. 1 and 2, which are a perspective exploded view and an assembled cross-sectional view of the touch panel with fingerprint recognition according to the first embodiment of the present invention, respectively. As shown in FIGS. 1 and 2, the touch panel with fingerprint recognition 1 of the present invention comprises a glass substrate 11, an electrode layer 12, a first insulated layer 13, and a fingerprint recognition sensing layer 14.

The glass substrate 11 has a first plane 11a and a second plane 11b. The first plane 11a and the second plane 11b are disposed on an upper side and a lower side of the glass substrate 11, respectively. The first plane 11a defines a touch area 11c and a non-touch area 11d which are adjacent to each other. That is, the touch area 11c is disposed outside of a non-touch area 11d.

The electrode layer 12 is disposed on the second plane 11b of the glass substrate 11. The electrode layer 12 has a plurality of first electrodes 121, a plurality of second electrodes 122, and a plurality of metal traces 123. The first electrodes 121 and the second electrodes 122 are selectively electrically connected to the metal traces 123. The metal traces 123 are disposed on the non-touch area 11d of the second plane 11b of the glass substrate 11.

The first insulated layer 13 covers an overlapping of the first electrodes 121 and the second electrodes 122. During the circuit layout, some portions of the first electrodes 121 and the second electrodes 122 may be overlapped and contacted to each other. The first insulated layer 13 is used to cover the first electrodes 121 (or the second electrodes 122) such that the second electrodes 122 (or the first electrodes 121) can be extends smoothly to crossover the first electrodes 121 (or the second electrodes 122) to avoid shorting between the first and second electrodes 121, 122 during the circuit layout.

The fingerprint recognition sensing layer 14 is disposed on the first plane 11a of the glass substrate 11 and has a plurality of fingerprint recognition chips 141 and a plurality of transmission lines 142. The fingerprint recognition chips 141 are electrically connected to the transmission lines 142.

Each of the fingerprint recognition chips 141 has a sensing area 141a and a top surface 141b. The sensing area 141a is formed on the top surface 141b.

The present invention mainly integrates the fingerprint recognition chips 141 of the fingerprint recognition sensing layer 14 and the electrode layer 12 together into the touch area 11c such that the accuracy of fingerprint recognition is improved and the manufacturing cost is decreased.

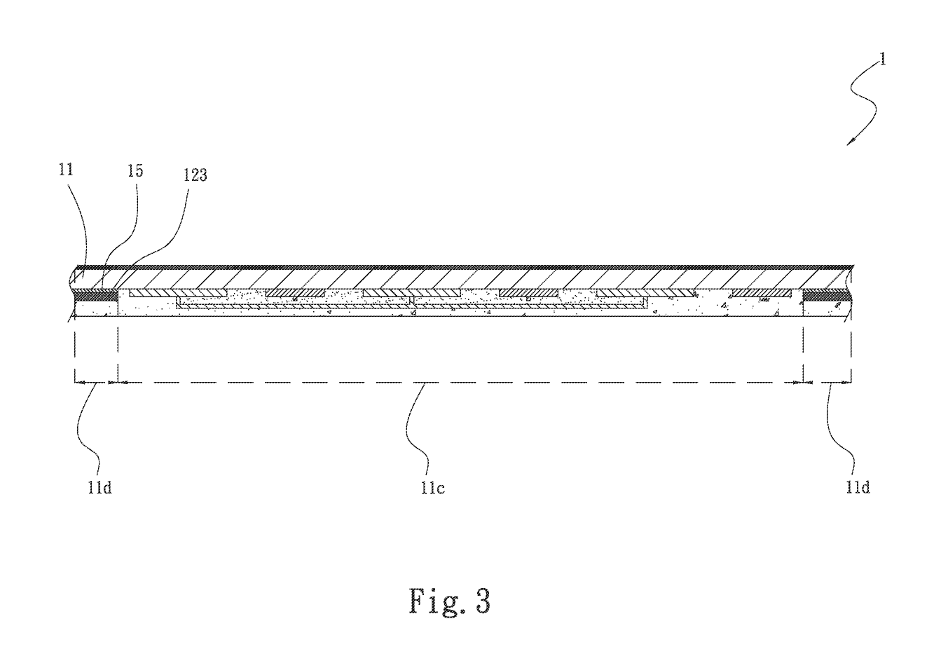

Please refer to FIG. 3, which is an assembled cross-sectional view of the touch panel with fingerprint recognition according to the second embodiment of the present invention. As shown in FIG. 3, some structural technical features of the current embodiment are the same as those of the first embodiment and will not be described here again. The difference is that in the current embodiment, the touch panel with fingerprint recognition 1 further comprises a shielding layer 15 which is disposed on the non-touch area 11d of the second plane 11b of the glass substrate 11 and is disposed between the glass substrate 11 and the metal traces 123. The shielding layer 15 shields the metal traces 123 and prevents the metal traces 123 from being exposed outside.

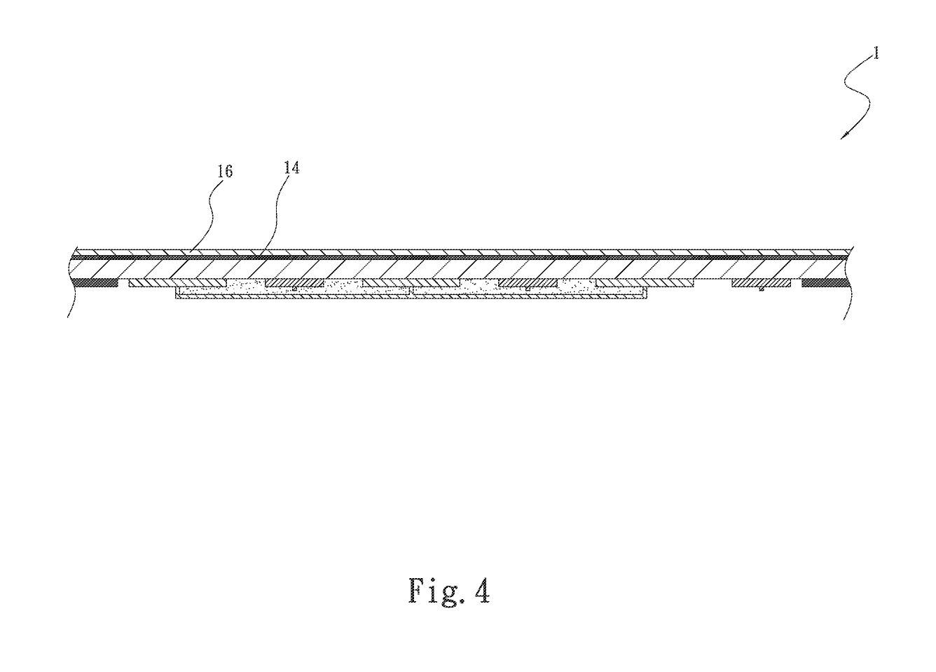

Please refer to FIG. 4, which is an assembled cross-sectional view of the touch panel with fingerprint recognition according to the third embodiment of the present invention. As shown in FIG. 4, some structural technical features of the current embodiment are the same as those of the first embodiment and will not be described here again. The difference is that in the current embodiment, the touch panel with fingerprint recognition 1 further comprises a protection layer 16 which covers the fingerprint recognition sensing layer 14 and is selected from the group consisting of epoxy resin, acrylic resin, and silicone. The protection layer 16 is used to prevent the back sides of the fingerprint recognition chips 141 from being exposed outside.

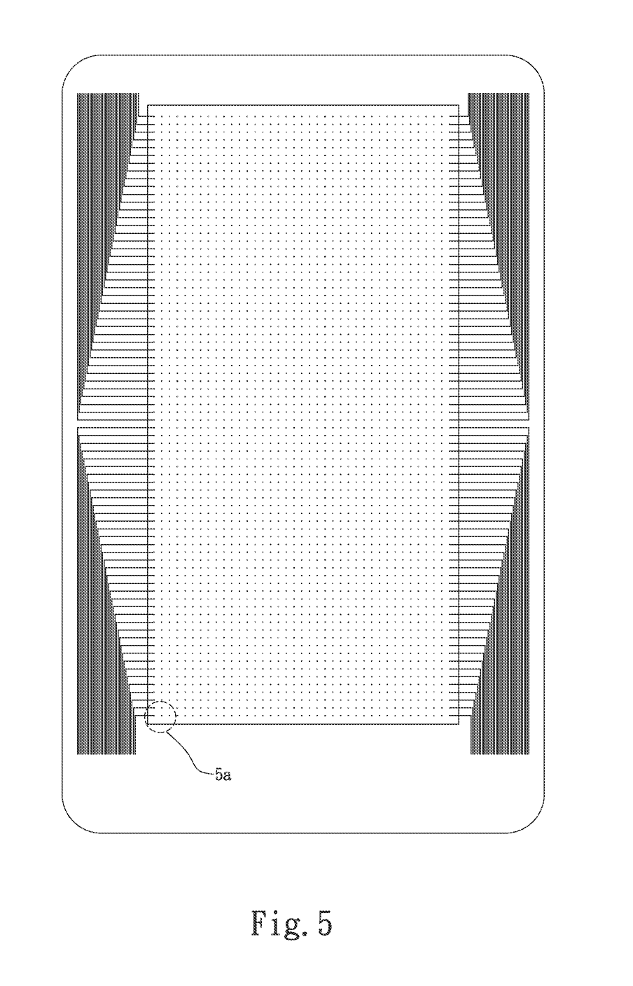

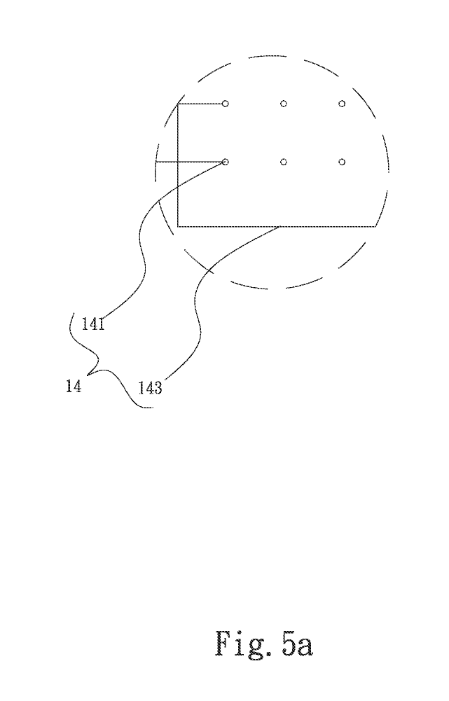

Please refer to FIGS. 5 and 5a, which are a top view of the fingerprint recognition sensing layer of the touch panel with fingerprint recognition according to the fourth embodiment of the present invention and a local enlarged view of FIG. 5, respectively. As shown in FIGS. 5 and 5a, some structural technical features of the current embodiment are the same as those of the first embodiment and will not be described here again. The difference is that in the current embodiment, the fingerprint recognition sensing layer 14 further comprises a plurality of metal lines 143 which are transparent and disposed adjacent to the fingerprint recognition chips 141. The metal lines 143 are mainly used to improve the recognition rate of the fingerprint recognition chips 141.

What is claimed is:

1. A touch panel with fingerprint recognition, comprising:
a glass substrate having a first plane and a second plane, wherein the first plane and the second plane are disposed on an upper side and a lower side of the glass substrate, respectively, wherein the first plane defines a touch area and a non-touch area which are adjacent to each other;
an electrode layer disposed on the second plane of the glass substrate, wherein the electrode layer has a plurality of first electrodes, a plurality of second electrodes, and a plurality of metal traces, wherein the first electrodes and the second electrodes are selectively electrically connected to the metal traces;
a first insulated layer covering an overlapping of the first electrodes and the second electrodes; and
a fingerprint recognition sensing layer disposed on the first plane of the glass substrate and having a plurality of fingerprint recognition chips and a plurality of transmission lines, wherein the fingerprint recognition chips are electrically connected to the transmission lines.

2. The touch panel with fingerprint recognition according to claim 1, wherein each of the fingerprint recognition chips has a sensing area and a top surface, wherein the sensing area is formed on the top surface.

3. The touch panel with fingerprint recognition according to claim 1, further comprising a shielding layer which is disposed on the non-touch area of the second plane of the glass substrate and is disposed between the glass substrate and the metal traces.

4. The touch panel with fingerprint recognition according to claim 1, further comprising a protection layer which covers the fingerprint recognition sensing layer and is selected from the group consisting of epoxy resin, acrylic resin, and silicone.

5. The touch panel with fingerprint recognition according to claim 1, wherein the metal traces are disposed in the non-touch area.

6. The touch panel with fingerprint recognition according to claim 1, wherein the fingerprint recognition sensing layer comprises a plurality of metal lines which are transparent and disposed adjacent to the fingerprint recognition chips.

7. The touch panel with fingerprint recognition according to claim 1, wherein the non-touch area is disposed outside of the touch-area.
